(19) United States
(12) Patent Application Publication
(10) Pub. No.: US 2026/0214639 A1
(43) Pub. Date: Jul. 23, 2026

(54) PAGING METHOD AND APPARATUS, STORAGE MEDIUM, TERMINAL DEVICE AND NETWORK DEVICE

(71) Applicant: Spreadtrum Semiconductor (Nanjing) Co., Ltd., Nanjing, Jiangsu (CN)

(72) Inventor: Zhenzhu LEI, Nanjing, Jiangsu (CN)

(73) Assignee: Spreadtrum Semiconductor (Nanjing) Co., Ltd., Nanjing, Jiangsu (CN)

(21) Appl. No.: 19/142,573

(22) PCT Filed: Dec. 15, 2023
(86) PCT No.: PCT/CN2023/139016

§ 371 Date: Jun. 23, 2025

(30) Foreign Application Priority Data
Dec. 23, 2022 (CN) 202211666433.1

(51) Int. Cl. H04W 68/02; H04W 74/0838

(52) U.S. Cl. CPC H04W 68/02; H04W 74/0838

(57) ABSTRACT

The present disclosure provides a paging method and apparatus, a storage medium, a terminal device and a network device. The method includes: transmitting paging transmission indication information or receiving the paging transmission indication information, where the paging transmission indication information is used to indicate that a paging transmission mode is to transmit a paging message at a paging occasion; and monitoring the paging occasion and receiving the paging message at the paging occasion.

### CROSS-REFERENCE TO RELATED APPLICATIONS

This application is a National Stage of International Application No. PCT/CN2023/139016, filed on Dec. 15, 2023, which claims priority to Chinese Patent Application No. 202211666433.1, entitled “PAGING METHOD AND APPARATUS, STORAGE MEDIUM, TERMINAL DEVICE AND NETWORK DEVICE”, filed with the China National Intellectual Property Administration on Dec. 23, 2022. The above two applications are hereby incorporated by reference in their entireties.

### TECHNICAL FIELD

The present disclosure relates to the field of communication technologies, and in particular, to a paging method and apparatus, a storage medium, a terminal device and a network device.

### BACKGROUND

To extend the battery life of a terminal device, the third generation partnership project (3GPP) is currently discussing the content related to low power wake-up signal (LP-WUS). When the terminal device is in a power-off state or a flight mode, the network can wake up the terminal device to perform related data transmission by transmitting a low power wake-up signal. That is, the terminal device determines whether to power on or exit the flight mode to enter an active state by receiving the low power wake-up signal. At this time, the terminal device performs the reception of the wake-up signal through an independent receiving circuit (since a main circuit for communication is in a powered-off state/flight mode and cannot receive any signals), the independent receiving circuit can also be referred to as a low-power wake-up receiver.

### SUMMARY

In a first aspect, a paging method is provided, which includes: transmitting paging transmission indication information or receiving the paging transmission indication information, where the paging transmission indication information is used to indicate that a paging transmission mode is to transmit a paging message at a paging occasion; and monitoring the paging occasion and receiving the paging message at the paging occasion.

In a second aspect, a paging method is provided, which includes: transmitting paging transmission indication information or receiving the paging transmission indication information, where the paging transmission indication information is used to indicate that a paging transmission mode is to transmit a paging message at a paging occasion; and transmitting the paging message at the paging occasion.

In a third aspect, a communication apparatus is provided, which includes: at least one processor and a memory; where the memory stores computer execution instructions; and the at least one processor, when executing the computer execution instructions stored in the memory, is configured to: transmit paging transmission indication information or receive the paging transmission indication information, where the paging transmission indication information is used to indicate that a paging transmission mode is to transmit a paging message at a paging occasion; and monitor the paging occasion and receive the paging message at the paging occasion.

In a fourth aspect, a communication apparatus is provided, which includes: at least one processor and a memory; where the memory stores computer execution instructions; and the at least one processor, when executing the computer execution instructions stored in the memory, is configured to: transmit paging transmission indication information or receive the paging transmission indication information, where the paging transmission indication information is used to indicate that a paging transmission mode is to transmit a paging message at a paging occasion; and transmit the paging message at the paging occasion.

In a fifth aspect, a computer readable storage medium is provided, on which a computer program is stored, where when the computer program is executed by a processor, any one of the methods provided by the first aspect or the second aspect is executed.

### BRIEF DESCRIPTION OF DRAWINGS

FIG. 1 is a flowchart of a paging method provided by an embodiment of the present disclosure.

FIG. 2 is an interaction flowchart of a paging method provided by an embodiment of the present disclosure.

FIG. 3 is another interaction flowchart of a paging method provided by an embodiment of the present disclosure.

FIG. 4 is yet another interaction flowchart of a paging method provided by an embodiment of the present disclosure.

FIG. 5 is yet another interaction flowchart of a paging method provided by an embodiment of the present disclosure.

FIG. 6 is yet another interaction flowchart of a paging method provided by an embodiment of the present disclosure.

FIG. 7 is a structural schematic diagram of a communication apparatus provided by an embodiment of the present disclosure.

FIG. 8 is a schematic diagram of a hardware structure of a communication apparatus provided by an embodiment of the present disclosure.

### DESCRIPTION OF EMBODIMENTS

The communication systems to which embodiments of the present disclosure are applicable include, but are not limited to, a long term evolution (LTE) system, a 5th-generation (5G) systems, new radio (NR) system, as well as a future evolved system or multiple communication convergence systems. Among them, the 5G system can be either a non-standalone (NSA) 5G system or a standalone (SA) 5G system. The technical solution of the present disclosure is also applicable to different network architectures, including but not limited to a relay network architecture, a dual connectivity architecture, and a vehicle-to-everything (V2X) communication architecture, among others.

The present disclosure mainly involves communication between a terminal device and a network device.

The network device in the embodiments of the present disclosure can also be referred to as an access network device. For example, it can be a base station (BS) (can also be called as a base station device). The network device is an apparatus deployed in a radio access network (RAN) to provide wireless communication functions. For example, in the 2nd-generation (2G) network, the apparatus that provides base station functions includes a base transceiver station (BTS). In the 3rd-generation (3G) network, the apparatus that provides base station functions includes a NodeB. In the 4th-generation (4G) network, the apparatus that provides base station functions includes an evolved NodeB (eNB). In wireless local area networks (WLAN), the apparatus that provides base station functions is an access point (AP). In NR, the apparatus that provides base station functions is a next-generation node base station (gNB), as well as a further evolved NodeB (ng-eNB). Communication between the gNB and the terminal device employs NR technology, and communication between the ng-eNB and the terminal device employs evolved universal terrestrial radio access (E-UTRA) technology. Both gNB and ng-eNB can be connected to the 5G core network. The network device in the embodiments of the present disclosure also includes devices for providing base station functions in future new communication systems.

The terminal device (terminal equipment) in the embodiments of the present disclosure can refer to various forms of access terminals, user units, user stations, mobile stations, mobile stations (MS), remote stations, remote terminals, mobile devices, user terminals, wireless communication devices, user agents, or user apparatuses. The terminal device can also be a cellular phone, a cordless phone, a session initiation protocol (SIP) phone, a wireless local loop (WLL) station, a personal digital assistant (PDA), a handheld device with wireless communication functions, a computing device, or other processing devices connected to a wireless modem, a vehicle-mounted device, a wearable device, a terminal device in the future 5G network, or a terminal device in the future-evolved public land mobile network (PLMN), etc., which are not limited in the embodiments of the present disclosure. The terminal device can also be referred to as a user equipment (UE) or terminal.

After introducing the low-power wake-up signal, how the network pages the terminal device is a problem that needs to be solved currently.

In the related art, a network can transmit a paging message to a terminal device through a low-power wake-up signal, that is, the terminal device in a deep sleep state or a flight mode can receive the low-power wake-up signal through a low-power wake-up receiver to obtain the paging message. After receiving its own paging message, the low-power wake-up receiver wakes up a main communication receiver to perform random access procedure, and then proceed with data reception. In this case, there are two modes for the network device to transmit the paging message. One mode is to transmit the paging message to the terminal device (the main receiver of the terminal device is in a deep sleep or a power-off state) through the low-power wake-up signal. Another mode is to perform schedule of the paging message by transmitting paging downlink control information (DCI) (that is, the terminal device receives the paging message at corresponding paging occasion through the main receiver, which is the mode of the protocol in the related art).

However, for a given service cell, the network device is unaware of whether the terminal device residing in this service cell is in the deep sleep mode or in an idle/inactive state. As a result, when the network pages a certain terminal device, all cells in the entire tracking area need to transmit paging messages using both modes, leading to significant network energy consumption.

In the technical solution of the present disclosure, the terminal device enables the network device to transmit the paging message at the paging occasion by transmitting the paging transmission indication information to the network device. Alternatively, the network device transmits the paging transmission indication information to the terminal device, so that the terminal device can prepare according to the paging message transmitted at the paging occasion, monitor the paging occasion, and receive the paging message at the paging occasion. By setting the paging transmission indication information, the technical solution of the present disclosure enables the paging transmission mode between the network device and the terminal device to be clarified, avoiding the simultaneous use of two modes by the network device to transmit the paging message, thereby effectively reducing the network energy consumption during the paging transmission process.

To make the above-mentioned purposes, features and advantages of the present disclosure more obvious and understandable, the specific embodiments of the present disclosure are described in detail below in combination with the accompanying drawings.

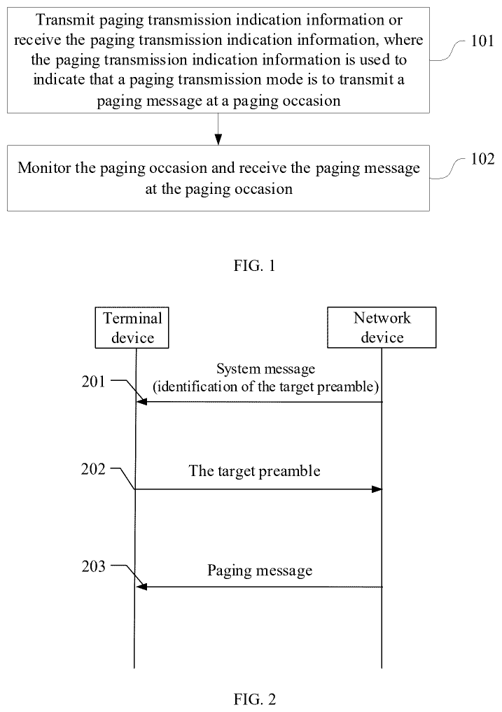

Referring to FIG. 1, the method provided by the present disclosure includes:

101: a terminal device transmits paging transmission indication information or receives the paging transmission indication information, where the paging transmission indication information is used to indicate that a paging transmission mode is to transmit a paging message at a paging occasion; and

102: the terminal device monitors the paging occasion and receives the paging message at the paging occasion.

In a specific implementation, the terminal device can transmit the paging transmission indication information to the network device, instructing the network device to transmit paging downlink control information at the paging occasion (PO) to schedule the paging message. In response to the paging transmission instruction information, the network device transmits the paging downlink control information at the paging occasion. The terminal device monitors the paging occasion, receives the paging downlink control information at the paging occasion, and receives the paging message based on the paging downlink control information.

Specifically, the terminal device includes a main communication receiver (which can also be referred to as a main communication module) and a low-power wake-up receiver (which can also be referred to as a low-power wake-up signal receiving module). The low-power wake-up receiver is configured to receive the low-power wake-up signal (LP-WUS). The main communication receiver is configured to receive other signals except for the low-power wake-up signal.

Therefore, when the terminal device transmits the paging transmission indication information to the network device, it can be transmitted by the main communication receiver of the terminal device.

It should be noted that the paging occasion can also be called paging moment, paging time, etc., which is not limited in the present disclosure.

In the specific implementation of 102, the terminal device monitors the paging occasion periodically, for example, according to the discontinuous reception (DRX) cycle. A paging occasion includes multiple paging monitoring occasions (PMO), and the number of paging monitoring occasions is consistent with the number of synchronization signal blocks (SSB) configured by the network, that is, each paging monitoring occasion corresponds to one synchronization signal block. The network device needs to transmit the same paging message in a direction of each synchronization signal block (beam). The terminal device selects an appropriate paging monitoring occasion based on its own measurement result to monitor the physical downlink control channel (PDCCH) and receive the paging message.

Furthermore, to save power consumption of the terminal device, in an idle state or an inactive state, one or more paging occasions can be associated with a paging early indication occasion (PEI-O). Before monitoring the paging occasion, the terminal device first obtains a paging early indication by monitoring the PEI-O associated with the paging occasion, to determine whether to monitor the paging occasion, so as to achieve the purpose of energy saving. A PEI-O includes multiple PDCCH monitoring occasions (MO), and the number of MOs is consistent with the number of synchronization signal blocks configured by the network, that is, each paging monitoring occasion corresponds to one SSB.

In this embodiment, the functions of the paging message include one or more of the following: (1) transmitting a call request to the terminal device in the idle state (RRC_IDLE); (2) notifying the terminal devices in the inactive state (RRC_IDLE/INACTIVE) and the active state (RRC_CONNECTED) that the system information has changed; (3) earthquake and tsunami notification: indicating the terminal device to start receiving a primary (primary) notification of an earthquake and tsunami warning system (, ETWS) and/or a secondary notification of the ETWS; indicating the terminal device to start receiving a notification of a commercial mobile alert service (CMAS). In NR, the terminal device can use the discontinuous reception mode to receive the paging message in the idle and inactive states to reduce power consumption.

In a specific embodiment of the present disclosure, please refer to FIG. 2, which shows an interactive diagram of a paging method. In this embodiment, the paging transmission indication information is a target preamble.

In 201, the network device transmits a system message, where the system message carries an identification of the target preamble. Correspondingly, the terminal device receives the system message.

In a specific implementation, the target preamble is at least one random access preamble from a set of contention-based random access preambles or at least one random access preamble from a set of contention-free random access preambles. The contention-based random access preambles are used for the terminal device to initiate a contention-based random access process, while the contention-free random access preambles are used for the terminal device to initiate a contention-free random access process.

In 202, the terminal device transmits the target preamble, and correspondingly, the network device receives the target preamble. Specifically, the terminal device transmits the target preamble on a physical random access channel (PRACH) resource.

In this embodiment, the paging transmission indication information is the target preamble. That is to say, for the network device, once the target preamble is received, it may need to use the paging occasion to transmit the paging message. Correspondingly, the target preamble will not be used for the random access process.

The terminal device in this embodiment is a terminal device in the idle state or the inactive state. Since the main communication receiver of the terminal device in the idle state or the inactive state is not turned off, the aforementioned terminal device can transmit the target preamble to a service cell.

In 203, the network device transmits a paging message. Correspondingly, the terminal device monitors a paging occasion and receives the paging message at the paging occasion.

Specifically, the network device transmits paging downlink control information (DCI) to perform schedule of the paging message. The terminal device, based on its own measurement result, selects an appropriate paging monitoring occasion in the paging occasion to monitor the PDCCH and receive the paging message.

Furthermore, the system message also includes a transmission period of the paging transmission indication information. The terminal device determines a position of a random access channel occasion (RO) resource based on configuration information of the RO resource. The RO resource is pre-configured periodic resource. The terminal device periodically transmits the paging transmission indication information on the RO resource according to the aforementioned transmission period. When the base station corresponding to the service cell receives the target preamble on the RO resource, it indicates that the paging transmission indication information transmitted by the terminal device has been received.

The terminal device in this embodiment may refer to the main communication receiver in the terminal device, that is, the aforementioned reception of the system message, transmission of the target preamble and reception of the paging message are all completed by the main communication receiver.

In a specific embodiment of the present disclosure, please refer to FIG. 3, which shows an interactive diagram of a paging method. In this embodiment, the paging transmission indication information is a preamble transmitted on a target physical random access channel resource.

In 301, the network device transmits a system message, where the system message carries a configuration parameter of a target PRACH resource. Correspondingly, the terminal device receives the system message.

In a specific implementation, the configuration parameter of the target PRACH resource can indicate a position of the RO resource, which can specifically include a period of the RO resource, a starting position of the RO resource, a frequency domain position and a time domain position of the RO resource.

In 302, the terminal device transmits a preamble on the target PRACH resource. Correspondingly, the network device receives the preamble on the target PRACH resource.

In this embodiment, the paging transmission indication information is the preamble transmitted on the target PRACH resource. That is to say, for the network device, once the preamble on the target PRACH resource is received, it can be known that the paging transmission mode is to transmit the paging message at the paging occasion. Correspondingly, the target PRACH resource will no longer be used for random access process.

The terminal device in this embodiment is a terminal device in the idle state or the inactive state. Since the main communication receiver of the terminal device in the idle state or the inactive state is not turned off, the aforementioned terminal device can transmit the preamble to a service cell.

In a specific implementation, the preamble transmitted by the terminal device on the target PRACH resource can be any preamble. Specifically, it can be a preamble selected from a contention-based random access preamble or a non-competitive random access preamble, and the preamble can also be used for random access process.

In 303, the network device transmits a paging message. Correspondingly, the terminal device monitors a paging occasion and receives the paging message at the paging occasion.

Specifically, the network device transmits paging downlink control information to perform schedule of the paging message. The terminal device, based on its own measurement result, selects an appropriate paging monitoring occasion in the paging occasion to monitor the PDCCH and receive the paging message.

Furthermore, the system message also includes a transmission period of the paging transmission indication information. The terminal device determines a position of the target PRACH resource based on the configuration parameter of the target PRACH resource. The terminal device periodically transmits the paging transmission indication information on the target PRACH resource according to the aforementioned transmission period. When the base station corresponding to the service cell receives the preamble on the target PRACH resource, it indicates that the paging transmission indication information transmitted by the terminal device has been received.

The terminal device in this embodiment may refer to the main communication receiver in the terminal device, that is, the aforementioned reception of the system message, transmission of the preamble and reception of the paging message are all completed by the main communication receiver.

In the technical solution of the present disclosure, the paging transmission indication information is the target preamble, or the paging transmission indication information is the preamble transmitted on the target physical random access channel resource. The technical solution of the present disclosure indicates that the paging transmission mode is to transmit the paging messages at the paging occasion by reusing the preamble or physical random access channel resource in the related art, without occupying additional resources, thereby saving transmission resources.

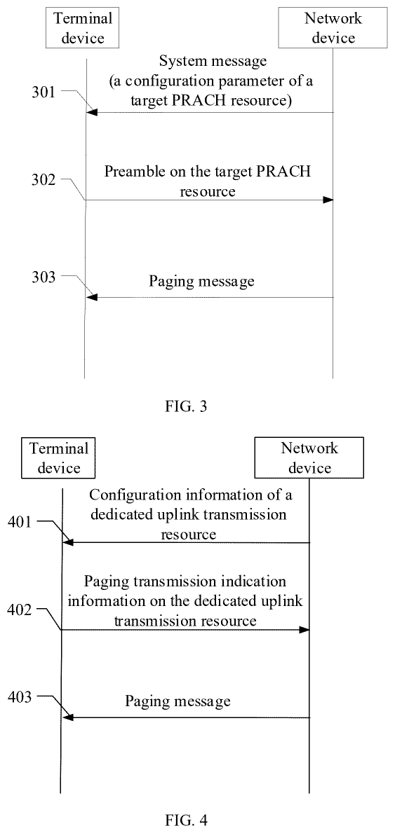

In a specific embodiment of the present disclosure, please refer to FIG. 4, which shows an interactive diagram of a paging method.

In 401, the network device transmits configuration information of a dedicated uplink transmission resource to the terminal device. The network device configures the dedicated uplink transmission resource for the terminal device, and the dedicated uplink transmission resource is used for transmitting paging transmission indication information.

In a specific implementation, the dedicated uplink transmission resource can be a periodic uplink transmission resource. Specifically, it can be a periodic physical uplink shared channel (PUSCH) resource.

In a specific implementation, the network device can transmit the configuration information of the dedicated uplink transmission resource to the terminal device, and the configuration information of the dedicated uplink transmission resource is used to indicate a position of the dedicated uplink transmission resource, such as time domain position, frequency domain position or time-frequency position. It can also indicate the period of the dedicated uplink transmission resource.

In 402, the terminal device transmits the paging transmission indication information on the dedicated uplink transmission resource. Correspondingly, the network device receives the paging transmission indication information on the dedicated uplink transmission resource.

The paging transmission indication information in this embodiment can be represented by a bit value. For example, a bit is used, and when the bit value is 1, it indicates that the paging transmission mode is to transmit a paging message at the paging occasion. For another example, when the bit value is 0, it indicates that the paging transmission mode is to transmit the paging message at the paging occasion.

The terminal device in this embodiment is a terminal device in the idle state or the inactive state. Since the main communication receiver of the terminal device in the idle state or the inactive state is not turned off, the aforementioned terminal device can transmit the paging transmission indication information to a service cell.

In 403, the network device transmits a paging message. Correspondingly, the terminal device monitors a paging occasion and receives the paging message at the paging occasion.

Specifically, the network device transmits paging downlink control information to perform schedule of the paging message. The terminal device, based on its own measurement result, selects an appropriate paging monitoring occasion in the paging occasion to monitor the PDCCH and receive the paging message.

Furthermore, the system message also includes a transmission period of the paging transmission indication information. The terminal device determines a position of the dedicated uplink transmission resource based on the configuration information of the dedicated uplink transmission resource. The terminal device periodically transmits the paging transmission indication information on the dedicated uplink transmission resource according to the aforementioned transmission period. The base station corresponding to the service cell receives the paging transmission indication information on the dedicated uplink transmission resource.

Further, if the network device does not receive the paging transmission indication information sent by any terminal device within a preset time length, it stops transmitting the paging message. Specifically, the network sets to stop transmitting the paging early indication and/or stop transmitting the paging message using the paging occasion.

The terminal device in this embodiment may refer to the main communication receiver in the terminal device, that is, the aforementioned reception of the configuration information of the dedicated uplink transmission resource, transmission of the paging transmission indication information and reception of the paging message are all completed by the main communication receiver.

In a specific implementation of the present disclosure, the network device (e.g., a base station) determines to transmit the paging message solely in a mode in which paging control information is transmitted using the paging occasion to schedule the paging message. The network device transmits the paging transmission indication information to the terminal device, ensuring that all terminal devices residing in the cell can only obtain the paging downlink control information in the mode of monitoring the paging occasion, and then receive the paging message according to the paging control information.

Specifically, in a case where the paging transmission indication information is carried in a low-power wake-up signal, a low-power wake-up receiver of the terminal device receives the low-power wake-up signal and obtains the paging transmission indication information. In a case where the paging transmission indication information is carried in the system message, the low-power wake-up receiver of the terminal device wakes up the main communication receiver, and the main communication receiver receives the paging transmission indication information.

Please refer to FIG. 5, which shows an interactive diagram of a paging method.

Unlike the aforementioned embodiments, in this embodiment, the terminal device receives paging transmission indication information, and the terminal device in this embodiment is a terminal device in a low-power wake-up mode. Specifically, the terminal device can be in a power-off state or a flight mode. Since the main communication receiver of the terminal device in the low-power wake-up mode is in a deep sleep or a power-off state, the aforementioned terminal device cannot actively transmit the message to the network device and can only receive the low-power wake-up signal.

In 501, the network device transmits a low-power wake-up signal that carries paging transmission indication information. Correspondingly, the terminal device receives the low-power wake-up signal.

Specifically, the low-power wake-up signal can be received by a low-power wake-up receiver of the terminal device.

In 502, the terminal device wakes up a main communication receiver in response to receiving the low-power wake-up signal.

In this embodiment, the network device determines to transmit the paging message at the paging occasion, and informs the terminal device to receive the paging message in a corresponding manner through the paging transmission indication information. Specifically, the paging transmission indication information may be a bit value of a newly added bit or a reserved bit in the low-power wake-up signal.

In 503, the network device transmits a paging message. Correspondingly, the terminal device monitors a paging occasion and receives the paging message at the paging occasion.

Specifically, the network device transmits paging downlink control information to perform schedule of the paging message. The main communication receiver of the terminal device, based on its own measurement result, selects an appropriate paging monitoring occasion in the paging occasion to monitor the PDCCH and receive the paging message.

Furthermore, the main communication receiver of the terminal device monitors the paging occasion at a time that is offset from a reception time of the paging transmission indication information by a target offset.

In a specific implementation, after the main communication receiver wakes up, it delays by M time units (such as time slots, symbols, subframes, wireless frames, etc.) to start monitoring PEI/PO. Specifically, the time unit can be the monitoring period of the low-power wake-up signal. For example, the monitoring period of the low-power wake-up signal is t1, and the target offset can be t1, 2t1, 3t1, etc.

In this embodiment, because different terminal devices may receive the paging transmission indication information and wake up main communication receivers at different times, some of the terminal devices may not receive the paging message if the network device transmits it too early (because the main communication receiver has not yet been woken up); Therefore, the time for the network device to transmit the paging message can be delayed, and correspondingly, the terminal device can also delay the time for receiving the paging message. That is to say, after the main communication receiver is woken up, the terminal device delays M time units to start monitoring PEI/PO, so as to ensure that the paging message can be received correctly, avoid unnecessary monitoring and reduce power consumption.

It should be noted that the target offset can be configured by the network device or specified by the communication standard protocol, which is not limited in the present disclosure.

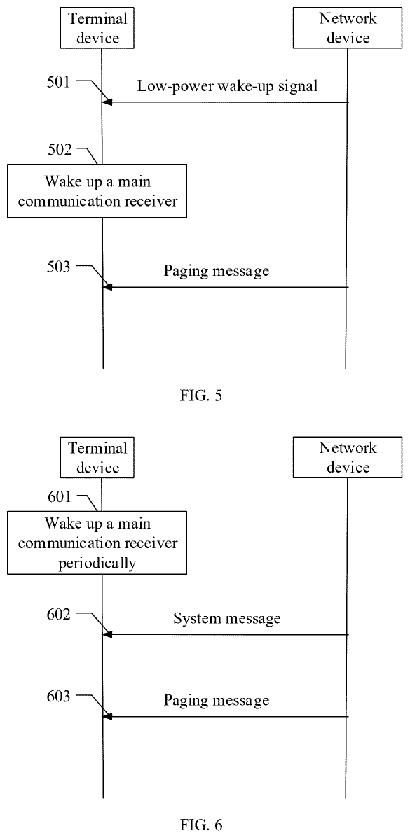

Please refer to FIG. 6, which shows yet another interactive diagram of a paging method.

Unlike the embodiment shown in FIG. 5 in which the main communication receiver is woken up by the low-power wake-up signal, the main communication receiver can be woken up periodically in the embodiment of the present disclosure. This is because the system message is transmitted periodically, and in order to enable the main communication receiver to receive the system message, the main communication receiver can be woken up periodically.

In 601, the terminal device periodically wakes up a main communication receiver.

Specifically, the network device can configure a reception period of a system message, and a low-power wake-up receiver of the terminal device periodically wakes up the main communication receiver according to the reception period to perform the reception of the system message.

In 602, the main communication receiver of the terminal device receives a system message. The system message carries paging transmission indication information.

In this embodiment, the network device determines to transmit the paging message at the paging occasion, and informs the terminal device to receive the paging message in a corresponding manner through the paging transmission indication information. Specifically, the paging transmission indication information may be a bit value of a newly added bit or a reserved bit in the system message.

In 603, the network device transmits a paging message. Correspondingly, the terminal device monitors a paging occasion and receives the paging message at the paging occasion.

In the above embodiments, a unified paging transmission mode is determined between the network device and the terminal device through the paging transmission indication information, so that the network device can transmit the paging message according to the determined transmission mode, and also ensure that the terminal device can correctly receive the paging message, and the network energy consumption in the paging transmission process is reduced on the basis of ensuring the correct transmission of the paging message.

It should be pointed out that the sequence number of each step in this embodiment does not represent a limitation on the execution order of each step.

It can be understood that in specific implementation, the paging method can be realized in the form of a software program, the software program runs in a processor integrated in a chip or chip module. The method can also be implemented in a manner that combines software and hardware, which is not limited in the present disclosure.

For more specific implementations of the embodiments of the present disclosure, please refer to the aforementioned embodiments, and will not repeat here.

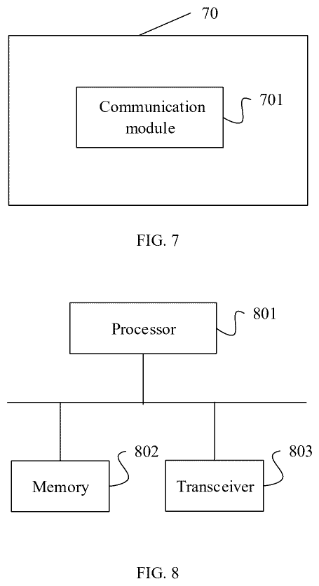

Please refer to FIG. 7, which shows a communication apparatus 70. The communication apparatus 70 can include:

a communication module 701, configured to transmit paging transmission indication information or receive the paging transmission indication information, where the paging transmission indication information is used to indicate that a paging transmission mode is to transmit a paging message at a paging occasion;

the communication module 701 is further configured to monitor the paging occasion and receive the paging message at the paging occasion.

In a specific implementation, the aforementioned communication apparatus 70 can correspond to a chip with communication function in the terminal device, such as a system-on-a-chip (SOC), a baseband chip, etc. Or it corresponds to a chip module with communication function included in the terminal device. Or it corresponds to a chip module with a data processing function chip, or a terminal device.

Further, the communication module 701 transmits a target preamble on a physical random access channel resource.

Further, the communication module 701 transmits a preamble on a target physical random access channel resource.

Further, the communication module 701 transmits the paging transmission indication information on a dedicated uplink transmission resource.

Further, the communication module 701 is a main communication receiving module configured to receive a system message; or the communication module 701 is a low-power wake-up receiver configured to receive a low-power wake-up signal. The system message or low-power wake-up signal carries the paging transmission indication information.

In a non-restrictive embodiment, the communication module 701 is configured to transmit paging transmission indication information or receive the paging transmission indication information, where the paging transmission indication information is used to indicate that a paging transmission mode is to transmit a paging message at a paging occasion; the communication module 701 is further configured to transmit the paging message at the paging occasion.

Further, the communication module 701 is configured to, if the paging transmission indication information is not received within a preset time length, stop transmitting the paging message at the paging occasion.

Further, the communication module 701 is configured to transmit a system message or a low-power wake-up signal, where the system message or the low-power wake-up signal carries the paging transmission indication information.

Further, the communication module 701 is configured to transmit a system message, where the system message carries an identification of a target preamble, a configuration parameter of a target physical random access channel resource, or configuration information of a dedicated uplink transmission resource.

In a specific implementation, the aforementioned communication apparatus 70 can correspond to a chip with communication function in the network device, such as a SOC, a baseband chip, etc. Or it corresponds to a chip module with communication function included in the network device. Or it corresponds to a chip module with a data processing function chip, or a network device.

Other related descriptions about the communication device 70 can refer to the related descriptions in FIG. 1 to FIG. 6 and their corresponding embodiments, and are not repeated here.

Each module/unit included in each apparatus or product described in the above embodiments may be a software module/unit or a hardware module/unit, or may be partly a software module/unit and partly a hardware module/unit. For example, for apparatus(s) or product(s) applied to or integrated into a chip, all modules/units included therein may be implemented through hardware such as circuit(s), or at least part of modules/units may be implemented through software program(s) running on processor(s) integrated within the chip, while the remaining modules/units (if any) may be implemented through hardware such as circuit(s). For apparatus(s) or product(s) applied to or integrated within a chip module, all modules/units included therein may be implemented through hardware such as circuits, where different modules/units may reside on either the same component (e.g., a chip, circuit module, etc.) or different components of the chip module; alternatively, at least part of the modules/units may be implemented via software program(s) running on processor(s) integrated within the chip module, while any remaining modules/units (if any) may be implemented through hardware such as circuit(s). For apparatus(s) or product(s) applied to or integrated within a terminal, all modules/units included therein may be implemented through hardware such as circuits, where different modules/units may reside within either the same component (e.g., a chip, circuit module, etc.) or different components of the terminal; alternatively, at least part of the modules/units may be implemented via software program(s) running on processor(s) integrated within the terminal, while any remaining modules/units (if any) may be implemented through hardware such as circuit(s).

An embodiment of the present disclosure also discloses a storage medium, which is a computer readable storage medium, on which a computer program is stored, and when the computer program runs, the steps of the methods shown in FIG. 1 to FIG. 3 can be executed. The storage medium may include a read-only memory (ROM), a random access memory (RAM), a magnetic disk or an optical disk, etc. The storage medium may also include a non-volatile memory or a non-transitory memory, etc.

Please refer to FIG. 8, an embodiment of the present disclosure further provides a hardware structural schematic diagram of the communication apparatus. The apparatus includes a processor 801, a memory 802 and a transceiver 803.

The processor 801 may be a general central processing unit (CPU), a microprocessor, an application-specific integrated circuit (ASIC), or one or more integrated circuits for controlling the program execution of the solution of the present disclosure. The processor 801 may also include multiple CPUs, and the processor 801 may be a single-CPU processor or a multi-CPU processor. The processor here may refer to one or more devices, circuits or processing cores for processing data (such as computer program instructions).

The memory 802 may be ROM or other types of static storage devices that can store static information and instructions, RAM or other types of dynamic storage devices that can store information and instructions, or electrically erasable programmable read-only memory (EEPROM), compactdisc read-only memory (CD-ROM) or other compact disc storage, optical disc storage (including compact disc, laser disc, optical disc, digital versatile disc, Blu-ray disc, etc.), magnetic disc storage medium or other magnetic storage devices, or any other medium capable of carrying or storing the desired program code in the form of instructions or data structures and accessible by a computer, which are not limited in the embodiments of the present disclosure. The memory 802 can exist independently (in this case, the memory 802 can be located outside the apparatus or inside the apparatus) or can be integrated with the processor 801. The memory 802 may contain computer program codes. The processor 801 is used to execute the computer program code stored in the memory 802, so as to implement the method provided by the embodiment of the present disclosure.

The processor 801, the memory 802 and the transceiver 803 are connected by a bus. The transceiver 803 is used to communicate with other devices or communication networks. In an implementation, the transceiver 803 may include a transmitter and a receiver. The device in the transceiver 803 for implementing the receiving function can be regarded as a receiver, and the receiver is used to perform the receiving steps in the embodiment of the present disclosure. The device in the transceiver 803 for implementing the transmitting function can be regarded as a transmitter, and the transmitter is used to perform the transmitting steps in the embodiment of the present disclosure.

When the structural diagram shown in FIG. 8 is used to illustrate the structure of the terminal device involved in the above embodiment, the processor 801 is used to control and manage the actions of the terminal device, for example, to communicate with the above network device. The memory 802 is used to store the program code and data of the terminal device. When the processor runs the computer program, it can control the transceiver 803 to receive one or more of RRC signaling, MAC signaling and DCI.

When the structural diagram shown in FIG. 8 is used to illustrate the structure of the network device involved in the above embodiment, the processor 801 is used to control and manage the actions of the network device, for example, to communicate with the above terminal device. The memory 802 is used to store the program code and data of the network device. When the processor runs the computer program, it can control the transceiver 803 to receive one or more of RRC signaling, MAC signaling and DCI.

The embodiment of the present disclosure defines the unidirectional communication link from the access network to the terminal device as downlink, the data transmitted on the downlink is downlink data, and the transmission direction of the downlink data is called downlink direction. The unidirectional communication link from the terminal device to the access network is uplink, and the data transmitted on the uplink is uplink data, and the transmission direction of the uplink data is called uplink direction.

It should be understood that the term “and/or” in this text is only a kind of relationship describing associated objects, indicating that there can be three possible relationships. For example, A and/or B can represent that there are three relationships: A exists alone, both A and B exist simultaneously, and B exists alone. Additionally, the character “/” in this text indicates that the associated objects before and after it are in an “or” relationship.

The “multiple” appeared in the embodiments of the present disclosure refers to two or more.

The first and second descriptions appeared in the embodiments of the present disclosure are only for illustration and to distinguish the described objects, and there is no order and they do not represent any special limitation on the number of devices in the embodiments of the present disclosure and cannot constitute any restriction on the embodiments of the present disclosure.

The “connection” appeared in the embodiments of the present disclosure refers to various connection modes such as direct connection or indirect connection to realize communication between devices, and the embodiments of the present disclosure do not make any restrictions on this.

The above embodiments can be implemented in whole or in part through software, hardware, firmware or any other combination. When implemented using software, the above embodiments can be implemented in whole or in part in the form of computer program product. The computer program product includes one or more computer instructions or computer programs. When loading or executing the computer instructions or computer programs on a computer, the processes or functions described in the embodiments of the present disclosure are generated in whole or in part. The computer can be a general-purpose computer, a special-purpose computer, a computer network, or other programmable devices. The computer instructions can be stored in a computer readable storage medium or transmitted from one computer readable storage medium to another computer readable storage medium. For example, the computer instructions can be transmitted from one website site, computer, server or data center to another website site, computer, server or data center through wired or wireless means.

It should be understood that in the various embodiments of the present disclosure, the size of the sequence numbers of the aforementioned processes does not imply the order of execution. The execution order of each process should be determined based on its function and internal logic, and should not constitute any limitation on the implementation process of the embodiments of the present disclosure.

In the several embodiments provided in the present disclosure, it should be understood that the disclosed methods, apparatuses and systems can be realized in other ways. For example, the apparatus embodiments described above are merely illustrative. For example, the division of the unit is merely a logical functional division, and there can be another division method in actual implementation. For example, multiple units or components can be combined or integrated into another system, or some features can be omitted or not executed. Another point is that the coupling or direct coupling or communication connection between each other shown or discussed can be indirect coupling or communication connection through some interfaces, apparatuses or units, which can be in electrical, mechanical or other forms.

The units described as separate components may or may not be physically separate. The components displayed as units may or may not be physical units, that is, they may be located in one place or distributed across multiple network units. Some or all of these units can be selected according to actual needs to achieve the objectives of solution of this embodiment.

In addition, each functional unit in each embodiment of the present disclosure can be integrated into one processing unit, or each unit can be physically included separately, or two or more units can be integrated into one unit. The aforementioned integrated units can be implemented either in the form of hardware or in the form of a combination of hardware and software functional units.

The aforementioned integrated units implemented in the form of software functional units can be stored in a computer readable storage medium. The aforementioned software functional unit is stored in a storage medium, including several instructions for enabling a computer device (which can be a personal computer, server, or network device, etc.) to perform part of the steps of the methods described in various embodiment of the present disclosure.

The present disclosure provides a paging method and apparatus, a storage medium, a terminal device and a network device, which can effectively reduce network energy consumption during the paging transmission process.

To achieve the above objectives, the present disclosure provides the following technical solutions.

In a first aspect, a paging method is provided, which includes: transmitting paging transmission indication information or receiving the paging transmission indication information, where the paging transmission indication information is used to indicate that a paging transmission mode is to transmit a paging message at a paging occasion; and monitoring the paging occasion and receiving the paging message at the paging occasion.

In an implementation, the paging transmission indication information is a target preamble; and the transmitting the paging transmission indication information includes: transmitting the target preamble on a physical random access channel resource.

In an implementation, before the transmitting the paging transmission indication information, the method further includes: receiving a system message, where the system message carries an identification of the target preamble.

In an implementation, the target preamble is at least one random access preamble from a set of contention-based random access preambles or at least one random access preamble from a set of contention-free random access preambles.

In an implementation, the paging transmission indication information is a preamble transmitted on a target physical random access channel resource, and the transmitting the paging transmission indication information includes: transmitting the preamble on the target physical random access channel resource.

In an implementation, before the transmitting the paging transmission indication information, the method further includes: receiving a system message, where the system message carries a configuration parameter of the target physical random access channel resource.

In an implementation, the transmitting the paging transmission indication information includes: transmitting the paging transmission indication information on a dedicated uplink transmission resource.

In an implementation, before the transmitting the paging transmission indication information, the method further includes: receiving configuration information of the dedicated uplink transmission resource, where the configuration information is used to indicate a position of the dedicated uplink transmission resource, and the dedicated uplink transmission resource is a periodic resource.

In an implementation, the receiving the paging transmission indication information includes: receiving a system message or a low-power wake-up signal, where the system message or the low-power wake-up signal carries the paging transmission indication information.

In an implementation, before the monitoring the paging occasion, the method further includes: waking up a main communication receiver in response to receiving the paging transmission indication information.

In an implementation, the monitoring the paging occasion includes: taking a reception time of the paging transmission indication information as a starting time, and delaying by M time units to start monitoring the paging occasion, where M is a natural number.

In an implementation, the transmitting the paging transmission indication information or receiving the paging transmission indication information includes: transmitting or receiving the paging transmission indication information periodically.

In a second aspect, a paging method is provided, which includes: transmitting paging transmission indication information or receiving the paging transmission indication information, where the paging transmission indication information is used to indicate that a paging transmission mode is to transmit a paging message at a paging occasion; and transmitting the paging message at the paging occasion.

In an implementation, the paging method further includes: if the paging transmission indication information is not received within a preset time length, stopping transmitting the paging message at the paging occasion.

In an implementation, the transmitting the paging transmission indication information includes: transmitting a system message or a low-power wake-up signal, where the system message or the low-power wake-up signal carries the paging transmission indication information.

In an implementation, before the transmitting the paging transmission indication information, the method further includes: transmitting a system message, where the system message carries an identification of a target preamble, a configuration parameter of a target physical random access channel resource, or configuration information of a dedicated uplink transmission resource.

In a third aspect, a communication apparatus is provided, which includes: a communication module, configured to transmit paging transmission indication information or receive the paging transmission indication information, where the paging transmission indication information is used to indicate that a paging transmission mode is to transmit a paging message at a paging occasion; the communication module is further configured to monitor the paging occasion and receive the paging message at the paging occasion.

In a fourth aspect, a communication apparatus is provided, which includes: a communication module, configured to transmit paging transmission indication information or receive the paging transmission indication information, where the paging transmission indication information is used to indicate that a paging transmission mode is to transmit a paging message at a paging occasion; the communication module is further configured to transmit the paging message at the paging occasion.

In a fifth aspect, a computer readable storage medium is provided, on which a computer program is stored, where when the computer program is executed by a processor, any one of the methods provided by the first aspect or the second aspect is executed.

In a sixth aspect, a communication apparatus is provided, which includes a memory and a processor, the memory stores thereon a computer program executable on the processor, where when the processor runs the computer program, any one of the methods provided by the first aspect is executed.

In a seventh aspect, a communication apparatus is provided, which includes a memory and a processor, the memory stores thereon a computer program executable on the processor, where when the processor runs the computer program, any one of the methods provided by the second aspect is executed.

In an eighth aspect, a computer program product is provided, on which a computer program is stored, and the computer program is executed by a processor to execute any one of the methods provided by the first aspect or the second aspect.

In a ninth aspect, a communication system is provided, which includes the above terminal device and the above network device.

In a tenth aspect, an embodiment of the present disclosure further provides a chip (or data transmission apparatus) on which a computer program is stored, and when the computer program is executed by the chip, the steps of the above method are implemented.

In an eleventh aspect, an embodiment of the present disclosure further provides a system chip, which is applied in a terminal. The chip system includes at least one processor and an interface circuit, and the interface circuit and the at least one processor are interconnected by wires, and the at least one processor is used for executing instructions to execute any one of the methods provided by the first aspect or the second aspect.

Compared with the related art, the technical solution of the embodiments of the present disclosure has the following beneficial effects.

In the technical solution of the present disclosure, the terminal device enables the network device to transmit the paging message at the paging occasion by transmitting the paging transmission indication information to the network device. Alternatively, the network device transmits the paging transmission indication information to the terminal device, so that the terminal device can prepare according to the paging message transmitted at the paging occasion, monitor the paging occasion, and receive the paging message at the paging occasion. By setting the paging transmission indication information, the technical solution of the present disclosure enables the paging transmission mode between the network device and the terminal device to be clarified, avoiding the simultaneous use of two modes by the network device to transmit the paging message, thereby effectively reducing the network energy consumption during the paging transmission process.

Furthermore, the paging transmission indication information is the target preamble, or the paging transmission indication information is the preamble transmitted on the target physical random access channel resource. The technical solution of the present disclosure indicates that the paging transmission mode is to transmit the paging messages at the paging occasion by reusing the preamble or physical random access channel resource in the related art, without occupying additional resources, thereby saving transmission resources.

Although the present disclosure is disclosed as above, the present disclosure is not limited thereto. Any person skilled in the art may make various changes and modifications without departing from the spirit and scope of the present disclosure. Therefore, the protection scope of the present disclosure shall be based on the scope defined by the claims.

1. A paging method, comprising:
transmitting paging transmission indication information or receiving the paging transmission indication information, wherein the paging transmission indication information is used to indicate that a paging transmission mode is to transmit a paging message at a paging occasion; and
monitoring the paging occasion and receiving the paging message at the paging occasion.

2. The paging method according to claim 1, wherein the paging transmission indication information is a target preamble; and the transmitting the paging transmission indication information comprises:
transmitting the target preamble on a physical random access channel resource.

3. The paging method according to claim 2, before the transmitting the paging transmission indication information, further comprising:
receiving a system message, wherein the system message carries an identification of the target preamble.

4. The paging method according to claim 2, wherein the target preamble is at least one random access preamble from a set of contention-based random access preambles or at least one random access preamble from a set of contention-free random access preambles.

5. The paging method according to claim 1, wherein the paging transmission indication information is a preamble transmitted on a target physical random access channel resource, and the transmitting the paging transmission indication information comprises:
transmitting the preamble on the target physical random access channel resource.

6. The paging method according to claim 5, before the transmitting the paging transmission indication information, further comprising:
receiving a system message, wherein the system message carries a configuration parameter of the target physical random access channel resource.

7. The paging method according to claim 1, wherein the transmitting the paging transmission indication information comprises:
transmitting the paging transmission indication information on a dedicated uplink transmission resource.

8. The paging method according to claim 7, before the transmitting the paging transmission indication information, further comprising:
receiving configuration information of the dedicated uplink transmission resource, wherein the configuration information is used to indicate a position of the dedicated uplink transmission resource, and the dedicated uplink transmission resource is a periodic resource.

9. The paging method according to claim 1, wherein the receiving the paging transmission indication information comprises:
receiving a system message or a low-power wake-up signal, wherein the system message or the low-power wake-up signal carries the paging transmission indication information.

10. The paging method according to claim 9, before the monitoring the paging occasion, further comprising:
waking up a main communication receiver in response to receiving the paging transmission indication information.

11. The paging method according to claim 9, wherein the monitoring the paging occasion comprises:
taking a reception time of the paging transmission indication information as a starting time, and delaying by M time units to start monitoring the paging occasion, wherein M is a natural number.

12. The paging method according to claim 1, wherein the transmitting the paging transmission indication information or receiving the paging transmission indication information comprises:
transmitting or receiving the paging transmission indication information periodically.

13. A paging method, comprising:
transmitting paging transmission indication information or receiving the paging transmission indication information, wherein the paging transmission indication information is used to indicate that a paging transmission mode is to transmit a paging message at a paging occasion; and
transmitting the paging message at the paging occasion.

14. The paging method according to claim 13, further comprising:
in case where the paging transmission indication information is not received within a preset time length, stopping transmitting the paging message at the paging occasion.

15. The paging method according to claim 13, wherein the transmitting the paging transmission indication information comprises:
transmitting a system message or a low-power wake-up signal, wherein the system message or the low-power wake-up signal carries the paging transmission indication information.

16. The paging method according to claim 13, before the transmitting the paging transmission indication information, further comprising:
transmitting a system message, wherein the system message carries an identification of a target preamble, a configuration parameter of a target physical random access channel resource, or configuration information of a dedicated uplink transmission resource.

17. A communication apparatus, comprising:
at least one processor and a memory;
wherein the memory stores computer execution instructions; and
the at least one processor, when executing the computer execution instruction stored in the memory, is configured to;
transmit paging transmission indication information or receive the paging transmission indication information, wherein the paging transmission indication information is used to indicate that a paging transmission mode is to transmit a paging message at a paging occasion; and
monitor the paging occasion and receive the paging message at the paging occasion.

18. A communication apparatus, comprising:
at least one processor and a memory,
wherein the memory stores computer execution instructions; and
the at least one processor, when executing the computer execution instructions stored in the memory, is configured to perform steps of the paging method according to claim 13.

19. A non-transitory computer readable storage medium with a computer program stored thereon, wherein when the computer program is executed by a computer, steps of the paging method according to claim 1 are executed.

20-21. (canceled)

22. A non-transitory computer readable storage medium with a computer program stored thereon, wherein when the computer program is executed by a computer, steps of the paging method according to claim 13 are executed.
